(19) United States
(12) Patent Application Publication
(10) Pub. No.: US 2025/0023138 A1
(43) Pub. Date: Jan. 16, 2025

(54) BATTERY MODULE

(71) Applicant: Robert Bosch GmbH, Stuttgart (DE)

(72) Inventor: Markus Schmitt, Tamm (DE)

(21) Appl. No.: 18/753,309

(22) Filed: Jun. 25, 2024

(30) Foreign Application Priority Data
Jul. 11, 2023 (DE) 10 2023 206 590.8

(51) Int. Cl. H01M 10/6552; H01M 10/0525; H01M 10/42; H01M 10/613; H01M 10/647; H01M 10/658; H01M 50/209; H01M 50/227; H01M 50/507

(52) U.S. Cl. CPC H01M 10/6552; H01M 10/0525; H01M 10/4257; H01M 10/613; H01M 10/647; H01M 10/658; H01M 50/209; H01M 50/227; H01M 50/507

(57) ABSTRACT

A battery module includes a plurality of battery cells and has an electrical switching device. A first connection of the electrical switching device is electrically conductively connected to a battery cell of the plurality of battery cells by a first busbar. A second connection of the electrical switching device is electrically conductively connected by a second busbar to an overall voltage tap of the battery module. At least one heat pipe is thermally conductively connected to the electrical switching device and a temperature control body.

### BACKGROUND

The invention is based on a battery module.

A battery module usually has a plurality of individual battery cells, each of which has a positive voltage tap and a negative voltage tap, wherein the respective voltage taps are electrically conductively connected to each other for an electrically conductive serial and/or parallel connection of the plurality of battery cells to each other and can thus be interconnected to form the battery module. In particular, the battery cells can each have a first voltage tap, in particular a positive voltage tap, and a second voltage tap, in particular a negative voltage tap, which are electrically conductively connected to each other by means of cell connectors, so that an electrically serial and/or parallel connection is formed. Battery modules are themselves in turn interconnected into batteries or entire battery systems.

Electrical switching devices such as a relay, for example, are usually arranged between a voltage tap of a terminal battery cell of a battery module and the overall voltage tap of such a battery module and are used to switch the battery module or the battery, which comprises such a battery module, on and off.

In principle, such electrical switching devices must be actively cooled, especially as they carry the entire current of the battery module. For this purpose, the electrical switching device can be connected to a heat sink, such as a metal housing of the battery module.

Prior art in this regard includes, for example, DE 10 2022 203 908, DE 10 2022 203 860 and DE 10 2022 203 861, which describe cooling of an electrical switching device by means of liquid cooling or air cooling, wherein the heat sink is an integral part of a housing structure of the housing of the battery module.

In order to provide good heat dissipation of the electrical switching device, the housing of the battery module is preferably made of a metal with comparably good thermal conductivity—preferably as a die-cast aluminum component.

### SUMMARY

A battery module according to the disclosure offers the advantage that reliable temperature control, in particular cooling, of an electrical switching device of the battery module can be provided. In particular, such temperature control can be achieved directly or immediately by means of at least one heat pipe.

In accordance with the invention, a battery module with a plurality of battery cells, which are designed in particular as lithium-ion battery cells, is provided for this purpose.

The battery module also comprises an electrical switching device, in particular a relay.

A first connection of the electrical switching device is electrically conductively connected to a battery cell of the plurality of battery cells by means of a first busbar. In particular, the first busbar is electrically conductively connected to the battery cell and to the first connection of the electrical switching device. In particular, this therefore forms an electrical contact between the battery cell and the first connection.

A second connection of the electrical switching device is electrically conductive connected to an overall voltage tap of the battery module by means of a second busbar. In particular, the second busbar is electrically conductively connected to the overall voltage tap and to the second connection of the electrical switching device. In particular, this therefore forms an electrical contact between the overall voltage tap and the second connection.

Furthermore, at least one heat pipe is thermally conductively connected to the electrical switching device and a temperature control body.

Advantageous further developments and improvements of the device specified in the independent claim are possible by means of the measures listed in the dependent claims.

In particular, the first busbar is mechanically connected to the battery cell, in particular to a voltage tap of the battery cell, for example by means of a material bond, in particular by means of a welded connection. Furthermore, the first busbar is in particular mechanically connected to the first voltage tap of the electrical switching device, for example by means of a material bond, in particular by means of a welded connection.

In particular, the second busbar is mechanically connected to the overall voltage tap of the battery module, for example by means of a material bond, in particular by means of a welded connection. Furthermore, the second busbar is in particular mechanically connected to the second voltage tap of the electrical switching device, for example by means of a material bond, in particular by means of a welded connection.

This means that the electrically conductive connections between the first connection and the battery cell by means of the first busbar and between the second connection and the overall voltage tap by means of the second busbar can each be formed directly.

It should be noted that a heat pipe is a heat exchanger, also known as a heat pipe, which allows a high heat flow density by using the enthalpy of vaporization of a medium. This means that comparably large amounts of heat can be transferred over a small cross-sectional area. When heat is transferred to the heat pipe, liquid evaporates within the heat pipe, wherein the absorbed heat is transferred through the heat pipe to the temperature control body with a comparably small temperature difference. The heat can be released from the temperature control body by means of free or forced convection.

At this point, it should be noted that the plurality of battery cells are each designed in particular as prismatic battery cells. Prismatic battery cells each comprise a battery cell housing with a total of six lateral surfaces, which are arranged in pairs opposite each other and substantially parallel to each other. In addition, lateral surfaces arranged adjacent one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface.

It should also be noted at this point that a fuse can also be arranged between the second connection and the overall voltage tap. In particular, the fuse can be arranged inside the second busbar.

Furthermore, the plurality of battery cells is arranged adjacent to one another, in particular in a longitudinal direction of the battery module. In an adjacent arrangement of the battery cells in a longitudinal direction of the battery module, the battery cells are arranged adjacent to one another by way of their respective largest lateral surfaces, which are in particular each arranged perpendicular to the upper lateral surface and to the lower lateral surface. It should at this point be noted that the longitudinal direction of the battery module is in this case accordingly arranged perpendicular to the largest lateral surfaces of the battery cells.

It is expedient if the at least one heat pipe is arranged in an electrically insulating manner from the electrical switching device. In particular, the at least one heat pipe is arranged in an electrically insulating manner from the first connection, the second connection, the first busbar and the second busbar.

Preferably, the first heat pipe is arranged in an electrically insulating manner from the first internal connection and/or the second heat pipe is arranged in an electrically insulating manner from the second internal connection and/or the third heat pipe is arranged in an electrically insulating manner from the first internal connection and the second internal connection. As a result, an electrical path and a thermal path can be reliably separated from each other.

It is advantageous if the electrical insulation is provided by means of a spacer element designed to be electrically insulating. The first heat pipe, the second heat pipe and/or the third heat pipe are each accommodated in a spacer element. The spacer element is preferably designed as an plastic injection-molded component.

Furthermore, the electrical insulation can be formed by means of a balancing element designed to be electrically insulating. In particular, the balancing element designed to be electrically insulating can be designed as a gap pad, a gap filler or a thermally conductive adhesive to electrically insulate the at least one heat pipe from the electrical switching device. This offers the advantage that, in addition to electrical insulation, reliable thermal conductivity can also be created.

In particular, a thermally conductive compensating material, known as thermal interface material or TIM for short, can also be arranged in the area of the thermal connection between the at least one heat pipe and the electrical switching device. The thermally conductive balancing material is designed to be electrically insulating.

Preferably, the spacer element and/or the balancing element can comprise thermally conductive additives so that heat transfer can be reliably increased.

Furthermore, the at least one heat pipe can have the largest ratio of circumference to cross-sectional area in the area of the thermal connection between the at least one heat pipe and the electrical switching device. In other words, this means that the at least one heat pipe is comparably flatter in this area.

This can further increase heat transfer.

It is advantageous if the plurality of battery cells is accommodated in a housing of the battery module, wherein the housing is made of a plastic. In particular, the housing is designed as a plastic injection-molded component. This offers the advantage that electrical insulation is formed between the plurality of battery cells and the housing of the battery module. Furthermore, a plastic design offers the advantage that a comparable degree of freedom in the design of the housing can be provided and weight can be reduced compared to housings made of metal.

Preferably, the electrical switching device can be connected to the housing of the battery module, e.g. a base of the housing of the battery module, by means of mechanisms such as screw connections.

It is advantageous if the thermally conductive connection between the first heat pipe and the temperature control body and/or between the second heat pipe and the temperature control body and/or between the third heat pipe and the temperature control body is formed inside the housing of the battery module. This offers the advantage that a seal between the first heat pipe and the housing of the battery module and between the second heat pipe and the housing of the battery module is unnecessary and only a seal between the temperature control element and the housing of the battery module needs to be formed. For example, such a seal could be formed by means of a sealing ring accommodated in a sealing groove.

In particular, it is possible to specifically adapt the design of the temperature control element to the respective requirements, especially since the temperature control body is not an integral part of the housing.

It is advantageous if the temperature control body is arranged on the outside of the housing, wherein the temperature control body is designed in particular as an extruded heat sink. Arranging the temperature control body on an external side can facilitate reliable heat exchange with the surroundings of the battery module, in particular the ambient air. Furthermore, the temperature control body can be arranged almost anywhere on the outside of the housing.

Preferably, the temperature control body can be connected to the housing of the battery module, e.g. the outside of the housing of the battery module, by means of mechanisms such as screw connections.

### BRIEF DESCRIPTION OF THE DRAWINGS

Embodiment examples of the invention are shown in the drawings and explained in more detail in the following description.

Shown are:

FIG. 1 a perspective view of an embodiment of a battery module according to the invention,

FIG. 2 a plan view of the embodiment of the battery module according to the invention as shown in FIG. 1

FIG. 3 a sectional view from the side of the embodiment of the battery module according to the invention as shown in FIG. 1,

FIG. 4 a step in the manufacture of a battery module according to the invention,

FIG. 5 a further step in the manufacture of a battery module according to the invention,

FIG. 6 yet another step of manufacturing a battery module according to the invention and

FIG. 7 a sectional view of an embodiment of a battery module according to the invention.

### DETAILED DESCRIPTION

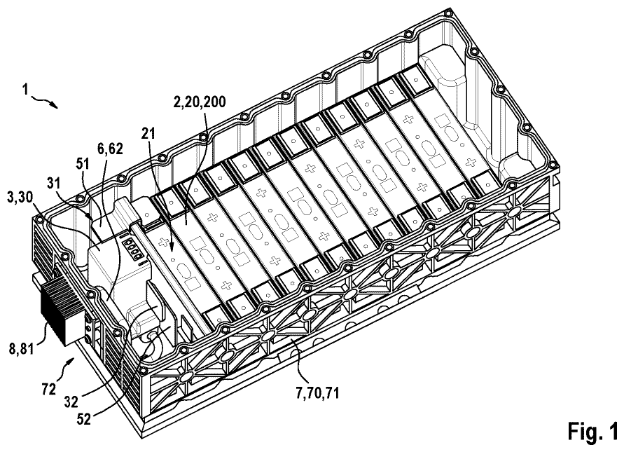

FIG. 1 shows a perspective view of an embodiment of a battery module 1 according to the invention.

The battery module 1 comprises a plurality of battery cells 2, which are designed in particular as lithium-ion battery cells 20. Furthermore, the battery cells 2 are designed in particular as prismatic battery cells 200.

Furthermore, the battery module 1 comprises an electrical switching device 3, in particular a relay 30.

The plurality of battery cells 2 and, in particular, the electrical switching device 3 are accommodated in a housing 7 of the battery module 1. The housing 7 is made of a plastic material 70. In particular, the housing 7 is designed as a plastic injection-molded component 71.

A first connection 31 of the electrical switching device 3 is electrically conductively connected to a battery cell 21 of the plurality of battery cells 2 by means of a first busbar 51.

For this purpose, the first busbar 51 is connected to the battery cell 21 and the first connection 31 in an electrically conductive manner.

A second connection 32 of the electrical switching device 3 is electrically conductively connected by means of a second busbar 52 to an overall voltage tap 4 of the battery module 1, which cannot be seen in FIG. 1.

In particular, the second busbar 52 is electrically conductively connected to the overall voltage tap 4 and the second connection 32.

Furthermore, at least one heat pipe 6, in particular a second heat pipe 62, is thermally conductively connected to the electrical switching device 3 and a temperature control body 8.

Furthermore, the temperature control body 8 is arranged on an outer side 72 of the housing 7. In particular, the temperature control body 8 is designed as an extruded heat sink 81.

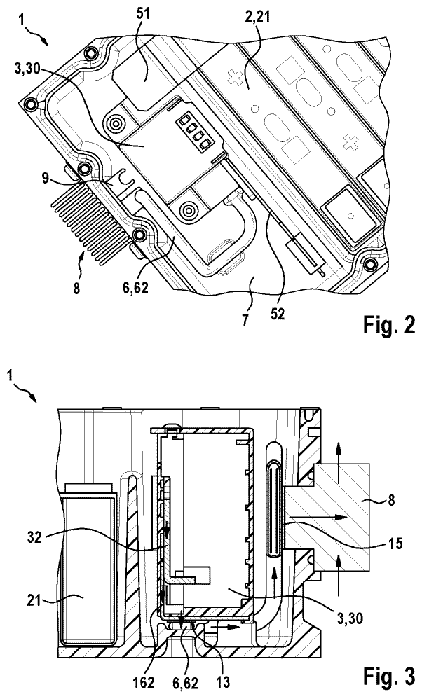

FIG. 2 shows the embodiment of the battery module 1 according to the invention as shown in FIG. 1 in a plan view, and FIG. 3 shows embodiment of the battery module 1 according to the invention as shown in FIG. 1 in a sectional view from the side.

FIGS. 2 and 3 will be described together below.

First of all, the plurality of battery cells 2 and the battery cell 21 can be seen.

In particular, it can be seen from FIG. 3 that the second connection 32 of the electrical switching device 3 forms a second internal connection 162 or is connected to a second internal connection 162.

Furthermore—which cannot be seen in the figures—the first connection 31 of the electrical switching device 3 can also form a first internal connection 161 or be connected to a first internal connection 161.

Here, a second heat pipe 62 is thermally conductively connected to the second internal connection 162.

Here, a first heat pipe 61 can also be thermally conductively connected to the first internal connection 161 and a third heat pipe 63 can be thermally conductively connected to the first internal connection 161 and the second internal connection 162.

The at least one heat pipe 6, in particular the first heat pipe 61, is arranged in an electrically insulating manner from the electrical switching device 3.

In particular, the second heat pipe 62 is designed to be electrically insulating from the second internal connection 162.

In particular, the first heat pipe 61 can also be arranged in an electrically insulating manner from the first internal connection 161 and the third heat pipe 63 can be arranged in an electrically insulating manner from the first internal connection 161 and the second internal connection 162.

In this case, such electrical insulation 11 is formed by means of a balancing element 13 designed to be electrically insulating.

In addition, the electrical insulation 11 could be formed by means of a spacer element 12, which is designed to be electrically insulating, and cannot be seen in the figures. For example, the first heat pipe 61, the second heat pipe 62 and/or the third heat pipe 63 can be accommodated within the spacer element 12.

FIG. 2 also shows that the thermally conductive connections 9 between the second heat pipe 62 and the temperature control body 8 are formed inside the housing 7 of the battery module 1.

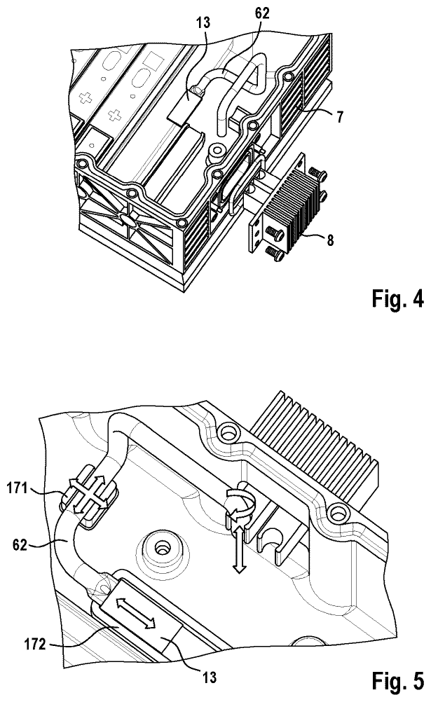

FIG. 4 shows a step in the manufacture of a battery module 1 according to the invention.

It can be seen that the second heat pipe 62 is accommodated in a housing 7 together with a balancing element 13.

FIG. 5 shows a further step in the manufacture of a battery module 1 according to the invention.

It can be seen that the second heat pipe 62 is received in a first receptacle 171 and that the balancing element 13 is received together with the second heat pipe 62 in a second receptacle 172. In particular, the second heat pipe 62 and the balancing element 13 can be reliably positioned by means of the first receptacle 171 and the second receptacle 172.

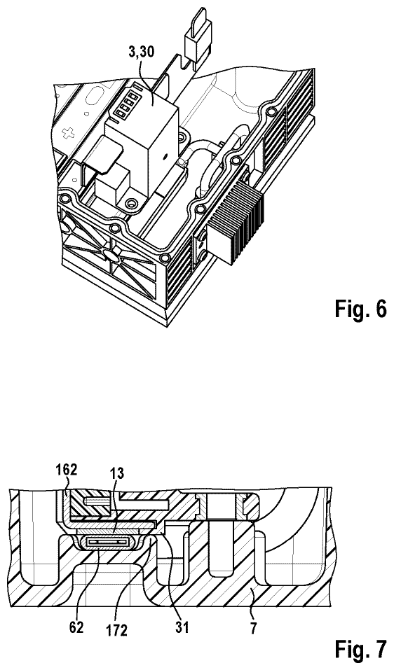

FIG. 6 shows yet a further step in the manufacture of a battery module 1 according to the invention.

It can be seen that the electrical switching device 3 is arranged in the housing 7.

FIG. 7 shows a sectional view of an embodiment of a battery module 1 according to the invention.

The second heat pipe 62 and the second internal connection 162, between which the balancing element 13 is arranged, can be seen.

Furthermore, the second receptacle 172 can also be seen, in which the second heat pipe 62 is accommodated together with the balancing element 13.

It can be seen here that a spacing between the second heat pipe 62 and the second internal connection 162 can be formed by means of the second receptacle 172.

1. A battery module having a plurality of battery cells (2), and
having an electrical switching device (3), wherein
a first connection (31) of the electrical switching device (3) is electrically conductively connected to a battery cell (21) of the plurality of battery cells (2) by a first busbar (51), and
a second connection (32) of the electrical switching device (3) is electrically conductively connected by a second busbar (52) to an overall voltage tap (4) of the battery module (1),
wherein
at least one heat pipe (6) is thermally conductively connected to the electrical switching device (3) and a temperature control body (8).

2. The battery module according to claim 1, wherein the first connection (31) of the electrical switching device (3) forms a first internal connection (161) or is connected to a first internal connection (161), and/or
the second connection (32) of the electrical switching device (3) forms a second internal connection (162) or is connected to a second internal connection (162), wherein
a first heat pipe (61) is thermally conductively connected to the first internal connection (161) and/or
a second heat pipe (62) is thermally conductively connected to the second internal connection (162) and/or
a third heat pipe (63) is thermally conductively connected to the first internal connection (161) and to the second internal connection (162).

3. The battery module according to claim 1, wherein the at least one heat pipe (6) is arranged in an electrically insulating manner from the electrical switching device (3).

4. The battery module according to claim 2, wherein the first heat pipe (61) is arranged in an electrically insulating manner from the first internal connection (161), and/or
the second heat pipe (62) is arranged in an electrically insulating manner from the second internal connection (162), and/or
the third heat pipe (63) is arranged in an electrically insulating manner from the first internal connection (161) and the second internal connection (162).

5. The battery module according to claim 4, wherein an electrical insulation (11) is formed by a spacer element (12), which is configured to be electrically insulating, wherein the first heat pipe (61), the second heat pipe (62) and/or the third heat pipe (63) are each accommodated in a spacer element (12).

6. The battery module according to claim 5, wherein the electrical insulation (11) is formed by a balancing element (13), which is configured to be electrically insulating.

7. The battery module according to claim 1, wherein the plurality of battery cells (2) are accommodated in a housing (7) of the battery module (1), wherein the housing (7) is formed from a plastic (70).

8. The battery module according to claim 7, wherein a thermally conductive connection (9) is formed between the first heat pipe (61) and the temperature control body (8), and/or between the second heat pipe (62) and the temperature control body (8), and/or between the third heat pipe (63) and the temperature control body (8), within the housing (7) of the battery module (1).

9. The battery module according to claim 7, wherein the temperature control body (8) is arranged on an outer side (72) of the housing (7).

10. The battery module according to claim 1, wherein the at least one heat pipe (6) has a largest ratio of circumference to cross-sectional area in a region of a thermal connection between the at least one heat pipe (6) and the electrical switching device (3).

11. The battery module according to claim 1, wherein the plurality of battery cells (2) are lithium-ion battery cells (20).

12. The battery module according to claim 1, wherein the electrical switching device (3) is a relay (30).

13. The battery module according to claim 7, wherein the housing (7) is as a plastic injection-molded component (71).

14. The battery module according to claim 9, wherein the temperature control body (8) is configured as an extruded heat sink (81).
